(19) United States
(12) Patent Application Publication
(10) Pub. No.: US 2004/0064920 A1
(43) Pub. Date: Apr. 8, 2004

(54) Multipurpose paper clip and spring clamp

(76) Inventor: Douglas Paul Arduini, Fremont, CA (US)

Correspondence Address: DOUGLAS P. ARDUINI, 46791 CRAWFORD STREET, FREMONT, CA, 94539-7146, US

(21) Appl. No.: 10/624,059

(22) Filed: Jul. 21, 2003

Related U.S. Application Data
(60) Provisional application No. 60/397,727, filed on Jul. 21, 2002.

(51) Int. Cl. B42F 1/02

(52) U.S. Cl. 24/67.9

(57) ABSTRACT

This invention is an improved paper or material clip or clamp that has the unique feature of a continuous strand or loop of spring-like wire or other material with dual clamping arms that connects to the dual crisscrossing spring-like legs, thereby allowing the clip or clamp to remain flat and undistorted with any thickness of clamped paper or material.

This invention is an improved spring-like clamp and paper clip, with the unique ability to expand over a wide range of displacement of thickness for clamping material or clipping paper. This invention includes, but is not limited to, the following advantages and improvements over prior art paper clips and clamps:

(a) minimize distortion, buckling, and deforming

(b) maintains form for long life and reuse with thick stacks of paper and material

(c) easy to apply and remove

(d) no damage to clipped papers and materials

(e) lays flat with paper or material thickness

(f) stackable with other stacks of clipped material or paper

(g) minimum or no interfere with, or get caught on, other papers or materials caused by distortion and design shape

(h) eliminates rejection of the clip or the clamped paper or material because of localized contact pressure on the edge, thereby eliminates a safety hazard of a flying clip or papers or material being shuffled or lost.

### CROSS-REFERENCE TO RELATED APPLICATIONS

This application claims the benefit of Provisional Patent Application No. 60/397,727 dated 07/21/2002.

### BACKGROUND

1. Field of Invention

This invention relates to spring clips and spring clamps, more specifically an improved multipurpose clip or clamp which can grip multiple papers or other materials with constant clamping pressure and little or no distortion for a wide range of thickness.

2. Description of Prior Art

There exists many types of paper clips and clamps for various purposes including clamping, binding, separating, book marking, clip boarding, indexing, etc. The most of the common paper clip or variations thereof are made with a discontinuous length of round metal wire with some degree of resiliency that is formed in two parallel clamping arms of various shapes. These two clamping arms engage the top and bottom sheets of a stack of papers and spring apart proportionally to the thickness of the stack of papers. The two clamping arms are joined together by a connecting leg that provides spring force from the wire resiliency for clamping force of the clamping arms on the paper stack. The spring force provided by the connecting leg is exhibited by bending and twisting torsion forces distributed along its length. This bending and twisting torsion in the single connecting leg is transferred to the clamping arms as a bending and rotational or twisting distortion and deformity to protrude away from the axis of the paper stack. The distortion of the clamping arms to the paper stack axes limits the clamping pressure to the adjacent to the edges of the paper stack and at the distal sharp end of the dual clamping arms only, thereby provides only a small clamping pressure to the stack. This distortion allows papers in the stack to come loose, get caught by other papers and stacks, and distort the thickness of the stack on the area of the clip(s). The distal sharp edges of the clamping arms tend to dig into the outer surface of the stack and make it necessary to further deform the clip in order to remove it from the stack without tearing the surface sheets. When used in books for markers, the pages and binding of the book may be damaged. As material thickness in increased between the clamping arms, the distortion increases to a point until the elastic limit is exceeded of the wire connecting leg which causes it to be permanently deformed and relatively useless.

In addition to the common paper clip, other clips of prior art have common problems that need improvement. These include, but are not limited to, binder clips, bulldog clips, banker clasps, and clip boards. Such clips suffer from one or more of the following disadvantages:

(a) limited thickness of paper and not expandable beyond their thickness;

(b) do not lie flat;

(c) thicker than the paper or material stack;

(d) distorts a pile when stacking because of their thickness or distortion;

(e) difficult or impossible to stack because of their thickness or bulk:

(f) tend to forcefully eject from thick group of papers;

(g) require finger manipulation and spreading of the legs for application, usually requiring both hands to clamp or unclamp;

(h) difficult to easily add or remove papers from the stack:

(i) easily deformed and therefore not reusable;

(j) and expensive and complex to build.

Many attempts have been made to improve the paper clip and similar spring clamps. But these conventional paper clips fail to keep the clamping arms or surfaces parallel with the paper or material over a wide range of thickness, thereby exhibiting distortion outside of the clamped or clipped material thickness. This distortion includes buckling and deforming of the clamping surfaces with increased added thickness of the clamped or clipped material. This distortion creates problems and disadvantages to their intended use such as:

(a) creates interference with each other material or papers when stacked;

(b) damage the clamped or clipped material surfaces;

(c) clamped material stack getting caught on other associated papers and materials;

(d) permanent distortion due to thick material and/or repeated use, thereby making it useless and trashed;

(e) and provides reduced gripping force limited only to the clipped edges of the clamped or clipped material or paper.

Many patents have been filed in this field but they have had only limited or no success in solving these distortion problems. For example, U.S. Pat. No. 2,211,034 to Stern relates only to folders and retaining contents of folders in place. It uses crisscrossing arms, but the material thickness is limited by the fixed height of the connecting bent portions and the spring action is in the clamping outer legs in the axis parallel to the clamped paper material. This also distorts the clamping arms with thicker material, therefore distortion is not mitigated.

U.S. Pat. No. 4,523,354 to Tsukamoto uses crisscrossing arms with additional bends after crossing in the center, which are unnecessary and adds manufacturing complexity. The two outer pressing units of the clamping arms are shorter and extend well beyond the inner clamp loop or back retainer, thereby lowering the effective clamping force and increases the twisting distortion of the two pressing units and inner curved part.

U.S. Pat. No. 4,597,139 to Lau is a metal wire paper clip structure where the wire of each U-shaped leg loop length ends that extend beyond the inter-connector spring loop curved radius to avoid distortion and damage to the paper and improved clasping force. Claims also include using spring-quality metal and steel wire. This design exhibits significant distortion.

U.S. Pat. No. 4,949,435 to Michelson is a paper clip with a single piece of bent wire having a straight top spine as a torque spring with respect to two bent side legs and bent cross arms that are each perpendicular to the top spine, to minimize angular distortion with thick papers. This design exhibits significant distortion.

U.S. Pat. No. 5,329,672 to Froehlich is a large capacity paper clip uses longer curved wire with more gradual curve shapes with given ratios of wire length to width to height than prior art which claims to be without distortion and buckling. But this design does not effectively mitigate distortion.

U.S. Pat. No. 6,163,934 to Fuster is a multi-purpose paper clip formed of flat cross section material with 2 crossing loops in a figure “8.” This invention has limited clamping pressure on the paper at the crossover point of the figure “8” and will exhibit distortion as material thickness increases.

### SUMMARY

In accordance with the present invention a spring clip comprises a continuous strand of resilient material forming dual crisscrossing spring-type legs connecting to dual clamping loop arms.

### OBJECTS AND ADVANTAGES

The object of the present invention is to provide an improved multipurpose paper clip and spring-type clip, clasp, or clamping device that provides significant improvements in performance to prior art devices. This improved multipurpose paper clip and spring clamp is for, but not limited to, clipping paper, clamping reports, clip board, book marking, bulletin boards, magnetic clips and clamps, or holding or positioning material and parts, etc. This invention may also be expanded for spring improvements in applications for parallel suspension expansion springs and shear spring expansion without torsion or twisting.

This invention provides improvements on prior art by providing the following unique features:

(a) constant and uniform clamping pressure on the material or paper over a wide surface area and variable thickness without exhibiting distortion

(b) starts flat and remains flat

(c) expands linearly to the variable thickness of the paper or material, thereby remaining flat against the paper or material to avoid catching on other material

(d) avoids interference with other material and papers when stacked

(e) no distal sharp edges of the clamping arms that tend to dig into the outer surface of the stack to damage to the clamped or clipped material surfaces

(f) and avoids getting caught on other associated papers and materials.

Note that in conventional paper clips the distortion shown in Fids. 1 and 2 lose their clamping area and pressure as more material thickness is added and the distortion of the clip increases. This is exactly the opposite effect as needed, where more clamping pressure is needed with more thickness of material.

Further objects and advantages of this invention will become apparent from a consideration of the drawings and ensuing description.

### SUMMARY OF THE INVENTION

The typical problem with existing paper clips and material clamps is distortion and buckling that occurs, thereby reducing the holding force and clamping effectiveness, but also interfering with and getting caught on other paper stacks or materials. The amount of distortion and buckling is increased by the thickness of the paper or material.

Two types of distortion or buckling are longitudinal bending and rotational torque or twisting, as shown with prior art in FIGS. 1 and 2 for standard and heavy-duty paper clips.

The present invention mitigates the distortion and buckling of the standard and heavy-duty paper clips. This is accomplished with a continuous strand of compliant or resilient material, such as but not limited to a spring-like wire, formed with dual crisscrossing spring-like legs in the X-axis that connect to dual clamping arms in the Y-axis that hold the clamped material between them. The dual crisscrossing spring-like legs provide continuous spring pressure over a wide range of paper thickness while enabling the dual claming arms to remain flat without twisting and bending distortion in the Z-axis as seen in prior art. The dual clamping arms therefore remain flat and undistorted with constant clamping pressure and contact friction on the top and bottom sides of the paper or paper stack for improved holding ability over prior art.

The object of the present invention to mitigate or eliminate distortion over a wide of paper thickness is to use a continuous strand or loop of resilient or compliant material like spring-type wire in a continuous strand or loop forming the dual crisscrossing spring-like legs and dual clamping arms as previously described. The dual crisscrossing arms each only exhibit one-halve of the spring tension exhibited by the prior art with a single crossing arm, therefore this allows use on a thicker stack of papers or the use a thinner lower cost strand of clip material in manufacturing without exceeding compliant range of the spring-like material causing permanently distorted. The dual crisscrossing spring-like arms exhibit a twisting torque and bending strain proportional to the clamped paper thickness at each end of each the dual crisscrossing spring-like arms that are equal and opposite to each other, which are then transferred to each of the connecting dual clamping arms which are continuous loops and cancel the torque and strain so that these is little or no cause for distortion. Also noted in that the longer the distance between crisscrossing spring-like legs, the less torque and strain that can cause distortion effects on the clamping arms.

A multipurpose spring clip or clamp according to the present invention provides improved and balanced clamping force on the clamping arms with various materials and wide range of thickness in many other applications with similar operation similar to the improved paper clip.

Basic variations of this invention use dual crisscrossing interconnecting spring-like legs with dual clamping arms of various shapes including, but not limited to;

(a) inner and outer or same width arms,

(b) upper and lower of similar or different widths,

(c) longer and shorter or same length arms and legs,

(d) triangular, circular, oval, or box-shaped

These basic variations and shapes are meant to have clamping arms that provide a balanced pressure with counter twisting action to the upper and lower arms and/or inner and outer to maintain parallel to each other and to the held material or paper, as shown in FIG. 4, and FIGS. 6-14.

Another variation of this invention includes the use of wide claming arms that can hold pages along the length of the page, acting as a binding for booklets, reports, notebook, binder, etc. similar to FIG. 15.

Another variation of this invention includes the addition or inclusion of a backing or cover to one or both clamping arms, such as a clip-board or a book cover(s) or a notebook cover(s).

Another variation of this invention in the material in construction can be made with any spring type material like wire, metal, plastic, composite, etc., and formed in a continuous loop with various processes, none of which are discussed in this patent. The continuous strand may be round in cross sectional shape like round wire, or any other shapes that may become apparent, such as but not limited to square or oval.

Another variation of this invention in the material in construction that makes up this clip or clamp may be a combination of different shapes of cross section and of different types of materials that may become apparent.

The main embodiment of the invention in FIG. 7-A with a continuous wire loop clamp or clip construction to eliminate gouging and damage to the material or paper being held.

The main advantages of this invention is to provide a design that eliminates or mitigates the distortion of prior art designs of paper clips and spring clamps, thereby maintaining constant pressure across the clamped paper or material. The key design advantage to this invention is to minimize or cancel the bending and twisting stresses that cause clip or clamp distortion, while maintaining a small profile relative to the clipped or clamped paper or other material.

There are several design features that combine to make this invention unique and thereby provide the ability to operate in a manor to mitigate the disadvantages in other designs of prior art, such as:

(a) dual crisscrossing legs are used in place of one leg that connect the two clamping arms that hold the clipped or clamped paper or material by top and bottom, thereby dividing the twisting and bending stresses by two with equal and opposite distortion forces into each clamping arm to lower the effects of distortion;

(b) increasing the length and thickness of the crisscrossing legs that lowers the twisting and bending stresses proportionally with the increasing thickness of the clamped paper or material, thereby lowering the distortion forces into each clamping arm;

(c) interconnecting each clamping arm to each dual crisscrossing spring-like leg using a continuous strand of material or wire, thereby canceling the equal and opposite distortion forces provided by dual legs proportional to their spring action as material thickness increases.

### BRIEF DESCRIPTION OF THE DRAWINGS

FIG. 1-A is a plan view of the prior art standard small paper clip that is greatly improved upon with this invention.

FIG. 1-B is a side view of FIG. 1-A that shows the typical problems of longitudinal distortion proportional to the thickness of the paper stack.

FIG. 1-C is an end view of FIG. 1-A that shows the typical problems of rotational distortion proportional to the thickness of the paper stack.

FIG. 2-A is a plan view of the prior art standard large heavy duty paper clip that is greatly improved upon with this invention.

FIG. 2-B is a side view of FIG. 2-A that shows the typical problems of longitudinal distortion proportional to the thickness of the paper stack.

FIG. 2-C is an end view of FIG. 2-A that shows the typical problems of rotational distortion proportional to the thickness of the paper stack.

FIG. 3 is a plan view of a conceptual form of a continuous loop of material in an oval shape that can be formed into the first embodiment according to the present invention of FIG. 4.

FIG. 4-A is a plan view of the first embodiment according to the present invention that may be formed from the original form in FIG. 3.

FIG. 4-B is an end view of FIG. 4-A showing a thin amount of clamped material or paper.

FIG. 4-C is an end view of FIG. 4-A showing a thick amount of clamped material or paper.

FIG. 5 is a plan view of a conceptual form a continuous loop of material in a rectangular shape that can be formed into a variation of the first embodiment according to the present invention of FIG. 6.

FIG. 6-A is a plan view of a variation of the first embodiment according to the present invention that may be formed from the original form in FIG. 5.

FIG. 6-B is an end view of FIG. 6-A showing a thick amount of clamped material or paper.

FIG. 7-A is a plan view of another variation of the first embodiment according to the present invention.

FIG. 7-B is an end view of FIG. 7-A showing a thick amount of clamped material or paper.

FIG. 8-A is a plan view of another variation of the first embodiment according to the present invention.

FIG. 8-B is an end view of FIG. 8-A with a thick amount of clamped material or paper.

FIG. 9-A is a plan view of another variation of the first embodiment according to the present invention.

FIG. 9-B is an end view of FIG. 9-A with a thick amount of clamped material or paper.

FIG. 10-A is a plan view of another variation of the first embodiment according to the present invention.

FIG. 10-B is an end view of FIG. 10-A with a thick amount of clamped material or paper.

FIG. 11 is a plan view of another variation of the first embodiment according to the present invention.

FIG. 12 is a plan view of another variation of the first embodiment according to the present invention.

FIG. 13 is a plan view of another variation of the first embodiment according to the present invention.

FIG. 14 is a plan view of another variation of the first embodiment according to the present invention.

FIG. 15 is a plan view of the second embodiment according to the present invention similar to the first embodiment but modified for applications such as binding of a notebook or booklet, formed from a continuous length of spring material, such as a wire or strand material.

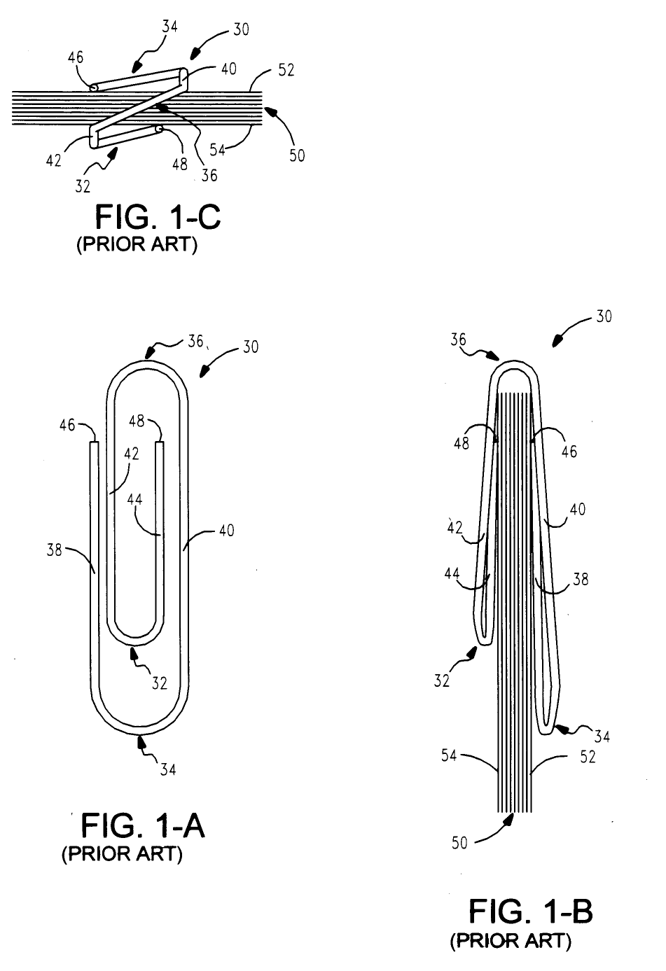

### DESCRIPTION—FIGS. 1-A, 1-B, AND 1-C—PRIOR ART, STANDARD SMALL PAPER CLIP

FIG. 1-A (plan view) of the prior art standard small paper clip 30 that is greatly improved upon with this invention. The wire form has a single spring-like leg 36 connects to the dual clamping arms 32 (inner) and 34 (outer) with the straight sides 40 and 42. The outer arm 34 connects to the third side 38 and both arms terminate at distal ends 46 and 48. FIG. 1-B (side view) and FIG. 1-C (end view) show the typical problems of longitudinal distortion and rotational distortion proportional to the thickness of the paper stack 50 with poor contact to the top sheet 52 and the bottom sheet 54.

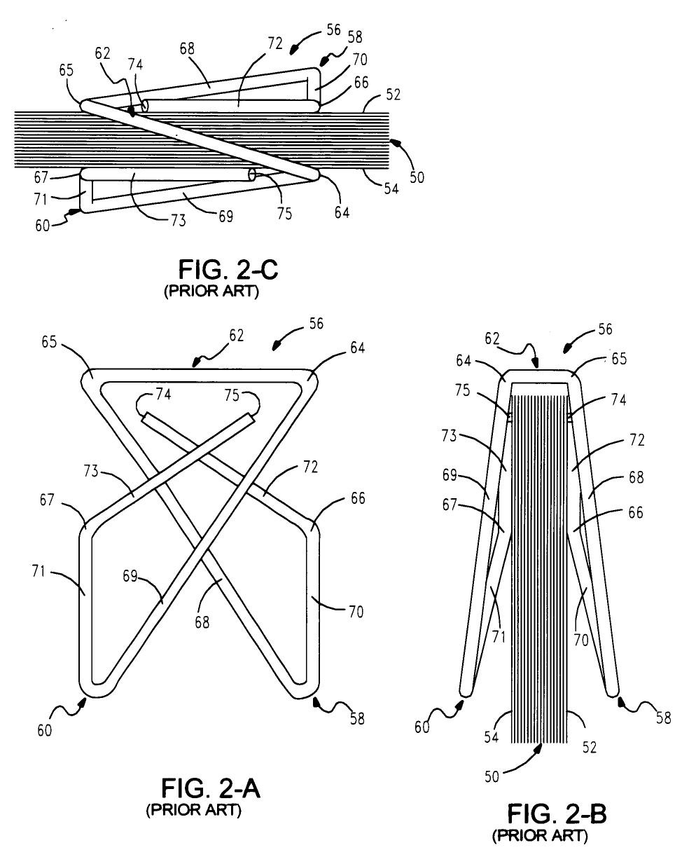

DESCRIPTION—FIGS. 2-A, 2-B, AND 2-C—PRIOR ART, L PAPER CLIP

FIG. 2-A (plan view) of the prior art standard large heavy-duty paper clip 56 that is greatly improved upon with this invention. The wire form has a single spring-like leg 62 is bent at 64 and 65 to connect to the dual clamping arms 60 (upper) and 58 (lower) with angled sides 68 and 69. The clamping arms 58 and 60 then connect to straight sides 70 and 71 with bends 66 and 67 to angled sides 72 and 73 and terminate at distal ends 74 and 75. FIG. 2-B (side view) and FIG. 2-C (end view) show the typical problems of longitudinal distortion and rotational distortion proportional to the thickness of the paper stack 50 with poor contact to the top sheet 52 and the bottom sheet 54.

### DESCRIPTION OF THE PREFERRED EMBODIMENTS

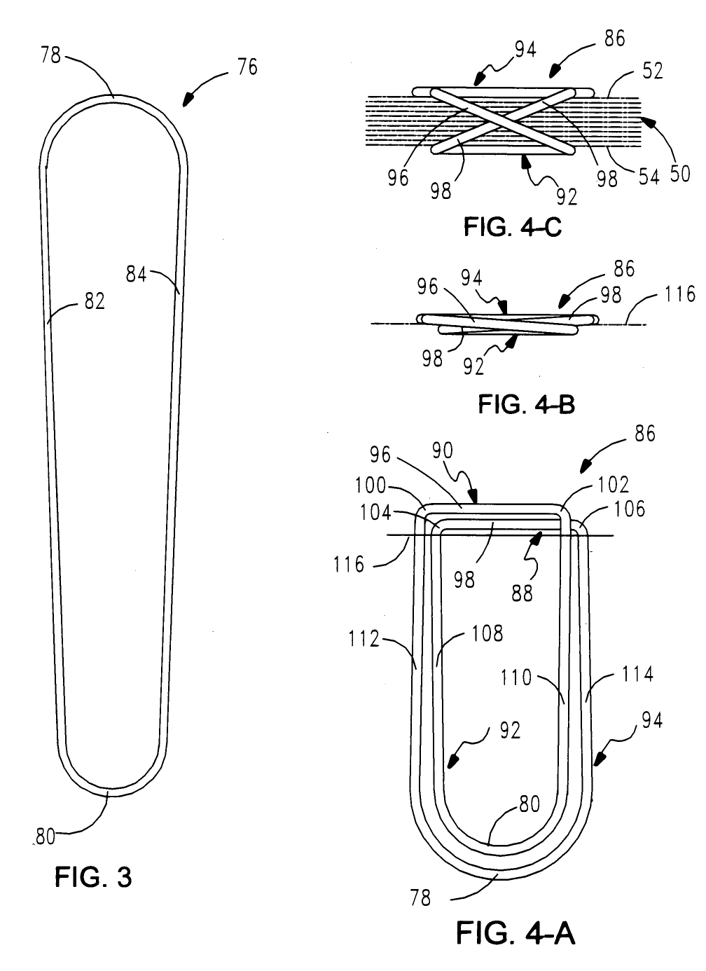

FIG. 4-A (plan view) and FIGS. 4-B and 4-C (end view) show the preferred embodiment of the present invention. This embodiment is an improved paper clip or other type material clip or clamp 86 that consists of a continuous strand or length or loop of compliant and resilient material that forms dual interconnecting spring-like legs 88 and 90 and dual clamping arms 92 and 94. A conceptual prefabrication form of a continuous oval formed strand of compliant material shape 76 in FIG. 3 (plan view) is shown as one possible method, but not meant to be the only method used to form the completed clip 86. This material shape 76 has a large loop end 78 connecting with 2 sides 82 and 84 to a smaller loop 80. The clip or clamp 86 is formed with dual crisscrossing interconnecting spring-like legs 88 and 90 that include 96 and 98 that each form corner bends 100, 102, 104, and 106 to form dual clamping arms 92 (inner) and 94 (outer). The inner loop clamping arm 92 has a continuous loop end 80 that interconnects with the sides 108 and 110 that interconnects through the bends 102 and 104 to the two crisscrossing legs 88 and 90 with interconnecting stand material 96 and 98. The outer loop clamping arm 94 has a continuous loop end 78 that interconnects with the sides 112 and 114 that interconnects through the bends 100 and 106 to the two crisscrossing legs 88 and 90 with interconnecting stand material 96 and 98. The edge of a single sheet of paper or material 116 is illustrated and compared to the thicker paper or material stack 50.

FIGS. 4-B and 4-C shows the features of the clip 86 expansion with thin and thick material thickness without elongation and distortion, thereby maintaining continuous pressure over the full length and width of the clamping arms.

The unique design of the embodiment of the present invention functions with the bending and twisting torsion forces on the dual crisscrossing legs 88 and 90 being equal and opposite forces on each end and is then cancelled through the continuous interconnection through the clamping arms 92 and 94 at 78 and 80. These bending and twisting forces would distort the clamping legs of a conventional paper clip as shown in FIGS. 1-B, 1-C, 2-B, and 2-C if not cancelled and negated with the continuous loop in the clamping arms 92 and 94 of this invention. A further improvement can be made of this invention with longer crisscrossing legs 88 and 90 proportional to the clamping arms or general clip size. This improvement is because the longer the length of the legs for a given material thickness, the less twisting and bending stress is introduced per unit length of spring material. Thereby with less bending and twisting stress, there is less stress along the length of the clamping arms 92 and 94 that needs to be cancelled as they connect at their ends 78 and 80.

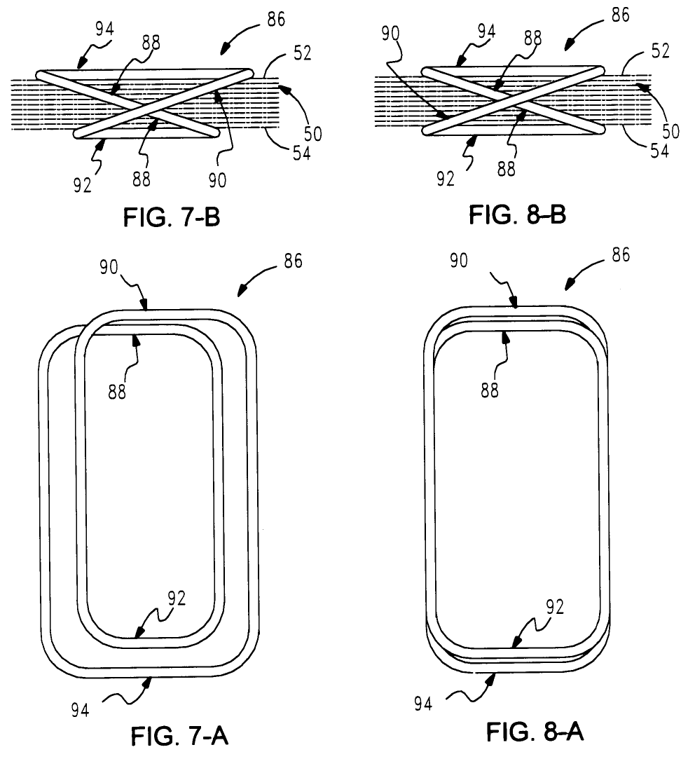

Other variations of the preferred embodiment of the present invention includes various shapes and various sizes of this embodiment include, but not limited to those shown in FIGS. 7-14. These variations are improved paper clips or other type material clips or clamps 86 that consists of a continuous strand or length or loop of compliant and resilient material that forms dual interconnecting spring-like legs 88 and 90 and dual clamping arms 92 and 94.

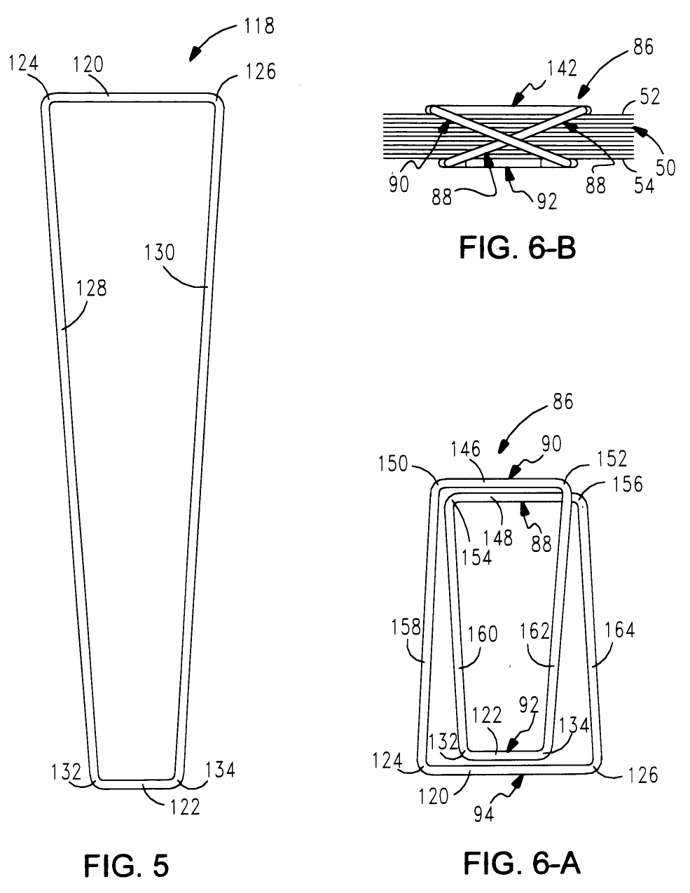

A conceptual prefabrication form of a continuous trapezoidal formed strand of compliant material shape 118 in FIG. 5 (plan view) is shown as one possible method, but not meant to be the only method used to form a variation of the preferred embodiment of the present invention of clip 86 in FIG. 6-A. This material shape 118 has a large closed end including 120 with corner bends 124 and 126 to connect with 2 sides 128 and 130 that connect to bends 132 and 134 to form the smaller closed loop end at 122.

FIG. 6-A is a variation of the preferred embodiment of the present invention which shows the clip or clamp 86 is formed with dual crisscrossing interconnecting spring-like legs 88 and 90 that include 146 and 148 that each form corner bends 150, 152, 154, and 156 to form dual clamping arms 92 (inner) and 94 (outer). The inner loop clamping arm 92 has a continuous loop end 122 with corners 132 and 134 that interconnects with the sides 160 and 162 that interconnects through the bends 152 and 154 to the two crisscrossing legs 88 and 90 with interconnecting stand material 146 and 148. The outer loop clamping arm 94 has a continuous loop end 78 with corners 124 and 126 that interconnects with the sides 158 and 164 that interconnects through the bends 150 and 152 to the two crisscrossing legs 88 and 90 with interconnecting stand material 146 and 148. The unique feature of a clip or clamp 86 with a continuous loop of spring-type material in the clamping arms 92 and 94 that interconnects to the dual crisscrossing spring-like legs 88 and 90, thereby allowing the clip or clamp to remain flat and undistorted with any thickness of clamped paper or material as shown in FIG. 6-B.

FIG. 7-A is another variation of the preferred embodiment of the present invention which shows example of an elongated box-shape with dissimilar clamping arm lengths and widths of the clip or clamp 86 is formed with dual crisscrossing interconnecting spring-like legs 88 and 90 and dual clamping rectangular arms 92 (inner and shorter) and 94 (outer and longer). FIG. 7-B shows the expansion with thick material thickness without elongation and distortion, thereby maintaining continuous pressure over the full length and width of the clamping arms.

FIG. 8-A is another variation of the preferred embodiment of the present invention which shows an example of an elongated box-shape with dissimilar clamping arm lengths and similar clamping arm widths of the clip or clamp 86 is formed with dual crisscrossing interconnecting spring-like legs 88 and 90 and dual clamping rectangular arms 92 (upper and shorter) and 94 (lower and longer). FIG. 8-B shows the expansion with thick material thickness without elongation and distortion, thereby maintaining continuous pressure over the full length and width of the clamping arms.

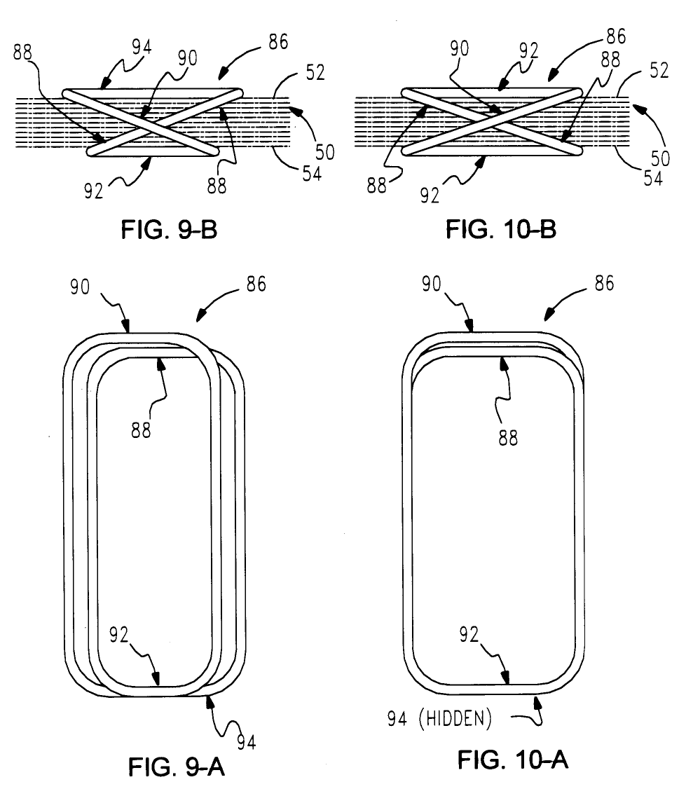

FIG. 9-A is another variation of the preferred embodiment of the present invention which shows an example of an elongated box-shape with similar clamping arm lengths and dissimilar clamping arm widths of the clip or clamp 86 is formed with dual crisscrossing interconnecting spring-like legs 88 and 90 and dual clamping rectangular equal length arms 92 (inner) and 94 (outer). FIG. 9-B shows the expansion with thick material thickness without elongation and distortion, thereby maintaining continuous pressure over the full length and width of the clamping arms.

FIG. 10-A is another variation of the preferred embodiment of the present invention which shows an example of an elongated box-shape with similar clamping arm lengths and similar clamping arm widths of the clip or clamp 86 is formed with dual crisscrossing interconnecting spring-like legs 88 and 90 and dual clamping rectangular equal length and width arms 92 (upper) and 94 (lower). FIG. 10-B shows the expansion with thick material thickness without elongation and distortion, thereby maintaining continuous pressure over the full length and width of the clamping arms.

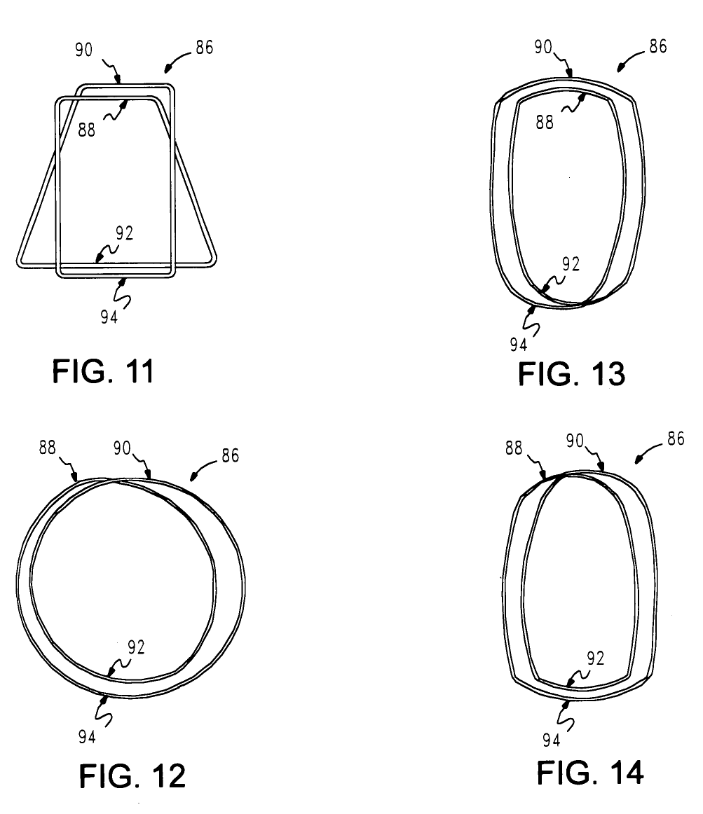

FIGS. 11, 12, 13, and 14 are other variations of the preferred embodiment of the present invention which shows the clip or clamp 86 is formed with dual crisscrossing interconnecting spring-like legs 88 and 90 and dual clamping rectangular equal length arms 92 (inner) and 94 (outer). FIG. 11 is an example of an elongated box-shaped and triangle-shaped variation with dissimilar clamping arm lengths and dissimilar clamping arm widths. FIG. 12 is an example of an oval-shaped variation with dissimilar clamping arm lengths and dissimilar clamping arm widths. FIG. 13 is an example of an elongated oval-shaped and square-shaped variation with dissimilar clamping arm lengths and dissimilar clamping arm widths. FIG. 14 is an inverted version of FIG. 13 example of an elongated oval-shaped and square-shaped variation with dissimilar clamping arm lengths and dissimilar clamping arm widths.

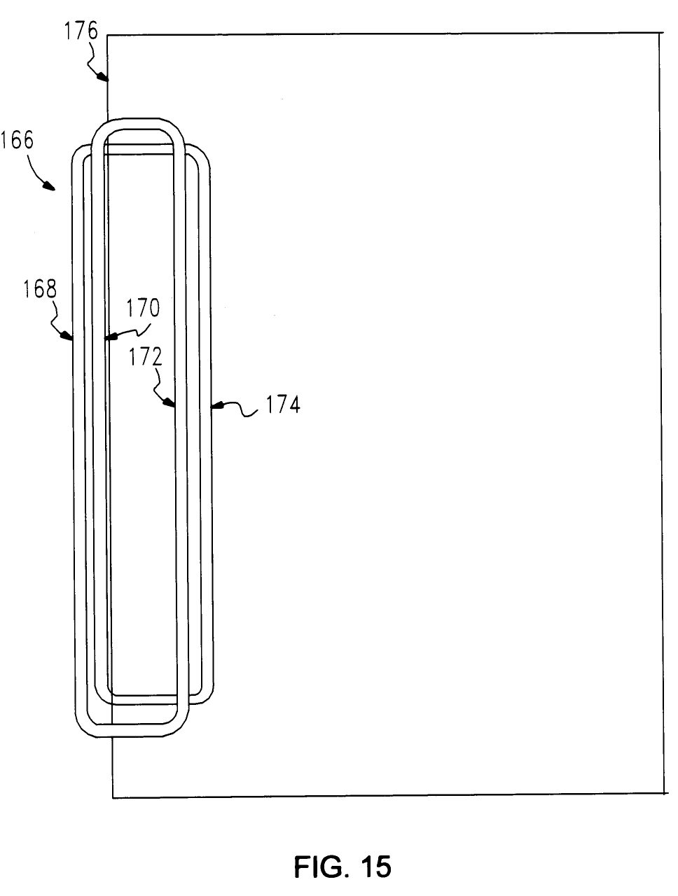

FIG. 15 is the second embodiment of the present invention. This embodiment is similar to the preferred embodiment of the invention and the other variations, but is an improved spring clip or clamp 166. It consists of a continuous strand or length or loop of compliant and resilient material that forms elongated rectangle-shaped dual clamping arms 172 and 174 connected to dual interconnecting crisscrossing spring-like legs 168 and 170. Clamped material 176 may be held firmly by the edge over a wide area such as in the margins of paper in a binder. This shape may be applicable or modified to use as a clip board or a binder for reports or books, as is shown with 176. Either clamping arm can be secured to a backing or cover for more flexibility in applications.

I claim:

1. A multi-purpose spring clip and clamp formed with a continuous strand of resilient and compliant material formed in such a way to provide dual crisscrossing spring-like legs interconnecting to dual clamping arms that clamp material between them with the ability to mitigate bending and torque stresses that tend to distort the clamping arms and therefore loose clamping pressure.

2. A multi-purpose spring clip and clamp in accordance with claim 1 wherein the upper and lower clamping arms are of various shapes and lengths and widths to provide optimum clamping force.

3. A multi-purpose spring clip and clamp in accordance with claim 1 wherein the dual crisscrossing legs are of various shapes and lengths and widths to provide optimum clamping force.

4. A multi-purpose spring clip and clamp in accordance with claim 1 wherein the dual crisscrossing legs connect to different materials or assemblies that act as an upper clamping arm and/or a lower clamping arm and/or other surfaces.

5. A multi-purpose spring clip and clamp in accordance with claim 1 wherein the dual crisscrossing legs are of various materials and shapes and in combination that perform as required for strength, rigidity, cost, to flex, to bend, to spring, or to grip to provide required operation and applications to the clamping arm(s) or legs(s).

6. A multipurpose spring clip and clamp formed of a continuous strand and endless loop of spring wire that begins forming into a long “U” shape loop is the first clamping arm as the inner clamping arm, then forming slightly different lengths to each side of the first arm, then each side be formed at right angles toward and crisscross passing each in a box form in the same relative parallel plane as the first arm and to act as dual crisscrossing connecting spring-like legs, then each end of the legs after passing slightly beyond the sides of the inner clamping arm will be formed at right angles to form a second long “U” shape loop with the remaining length of the endless continuous strand of wire. The second “U” shape loop is the second clamping arm and is formed in such a way to be wider and longer than the inner clamping arm and is in the same relative parallel plane with the inner clamping arm to be formed parallel to each other where paper can be clamped or clipped with continuous spring pressure between the inner and outer clamping arms created by the dual crisscrossing connecting spring-like legs expanding in the axis perpendicular to the axis of the clamping arms to the thickness of the paper or material stack.

7. A multipurpose clamp or clip in accordance with claim 6 wherein the spring wire is some other compliant and resilient spring-type material and/or shape.

8. A multipurpose clamp or clip in accordance with claim 6 wherein the dual clamping arms are of different widths or lengths or shapes for improved operation.

9. A multipurpose clamp or clip in accordance with claim 6 wherein any other material is clamped or clipped other than paper.

10. A multipurpose clamp or clip in accordance with claim 6 where one inner or outer clamping arm loop is part of a base or backing plate to act as a clip board or book binder or notebook binder or notepad and for various claming applications.

11. A multipurpose clamp or clip formed in such a way with a length of spring wire formed into dual crisscrossing spring-type legs that expand by the thickness of the paper or material being clamped or clipped and are connected to a lower clamping arm loop and also connected to an upper clamping arms, thereby providing continuous clamping pressure and mitigating bending and twisting distortion of the clamping arms.

12. A multipurpose clamp or clip in accordance with claim 11 wherein the spring wire is some other spring material and/or shape.

13. A multipurpose clamp or clip in accordance with claim 11 where the lower or upper clamping arm or arms is part of a base or backing plate to act as a clip board or book binder or notebook binder or notepad and for various clamping applications.
